(19) United States
(12) Patent Application Publication
(10) Pub. No.: US 2014/0074523 A1
(43) Pub. Date: Mar. 13, 2014

(54) RESERVATION SYSTEMS FOR ELECTRIC VEHICLE CHARGING STATIONS

(71) Applicant: Optimization Technologies, Inc., Portland, OR (US)

(72) Inventors: Dexter Turner, West Linn, OR (US); Damion j. Moyer, Portland, OR (US)

(73) Assignee: Optimization Technologies, Inc., Portland, OR (US)

(21) Appl. No.: 14/083,239

(22) Filed: Nov. 18, 2013

Related U.S. Application Data
(63) Continuation-in-part of application No. 14/065,200, filed on Oct. 28, 2013.
Application No. 14/065,200 is a continuation-in-part of application No. 14/047,842, filed on Oct. 7, 2013.
Application No. 14/047,842 is a continuation-in-part of application No. 14/014,108, filed on Aug. 29, 2013.
(60) Provisional application No. 61/728,134, filed on Nov. 19, 2012.
(60) Provisional application No. 61/719,483, filed on Oct. 28, 2012.
(60) Provisional application No. 61/710,643, filed on Oct. 5, 2012.
(60) Provisional application No. 61/694,647, filed on Aug. 29, 2012.

(51) Int. Cl. G06Q 10/02

(52) U.S. Cl. CPC G06Q 10/02
USPC 705/5

(57) ABSTRACT

Disclosed herein are representative embodiments of methods, apparatus, and systems relating to reservation systems to allow for the efficient use of electric vehicle charging stations (“EVCSs”) and electric vehicle supply equipment (“EVSE”) for the purpose of charging electric vehicles. For example, embodiments of the disclosed technology can be used to improve the basic process of charging an electric vehicle by more efficiently using all of the charging time that the electric vehicle charging station has available. In certain embodiments, the system is a reservation system that establishes a queue for use of the stations, allows users to enter the queue, notifies users when it is their turn to use the station, and only allows the next user in the queue to access the station.

### CROSS REFERENCE TO RELATED APPLICATIONS

This application claims the benefit of U.S. Provisional Application No. 61/728,134, filed on Nov. 19, 2012, and entitled “RESERVATION SYSTEMS FOR ELECTRIC VEHICLE CHARGING STATIONS”, which is hereby incorporated herein by reference.

This application is also a continuation-in-part of U.S. Nonprovisional application 14/065,200 filed on Oct. 28, 2013, and entitled “SYSTEM FOR COMBINING PAYMENT FOR ELECTRIC VEHICLE CHARGING AND PARKING”, which claims the benefit of U.S. Provisional Application No. 61/719,483 filed on Oct. 28, 2012, and entitled “SYSTEM FOR COMBINING PAYMENT FOR ELECTRIC VEHICLE CHARGING AND PARKING” and which is also a continuation-in-part of U.S. Nonprovisional Application No. 14/047,842 filed on Oct. 5, 2013, and entitled “SYSTEM FOR PARKING PAYMENT USING A MOBILE DEVICE,” which claims the benefit of U.S. Provisional Application No. 61/710,643 filed on Oct. 5, 2012, and entitled “SYSTEM FOR PARKING PAYMENT USING A MOBILE DEVICE,” and which is also a continuation-in-part of U.S. Nonprovisional Application No. 14/014,108, filed on Aug. 29, 2013 and entitled “ELECTRIC VEHICLE CHARGING STATION MOBILE DEVICE PAYMENT SYSTEM”, which claims the benefit of U.S. Provisional Application No. 61/694,647, filed on Aug. 29, 2012, and entitled “ELECTRIC VEHICLE CHARGING STATION MOBILE DEVICE PAYMENT SYSTEM”, all of which applications are hereby incorporated herein by reference.

### FIELD

This application relates to electric vehicle charging stations and associated systems.

### SUMMARY

Disclosed below are representative embodiments of methods, apparatus, and systems relating to a queuing-type reservation system to allow for the efficient use of electric vehicle charging stations (“EVCSs”) and electric vehicle supply equipment (“EVSE”) for the purpose of charging of electric vehicles. The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. Furthermore, any one or more of the features or aspects of the disclosed embodiments can be used in various combinations and subcombinations with one another.

Among the embodiments disclosed herein are a reservation system to control access to and payment for the use of electric vehicle charging station systems. Embodiments of the disclosed technology can be used to improve the basic process of charging an electric vehicle by more efficiently using all of the charging time that the electric vehicle charging station has available. In certain embodiments, the system is a round robin type of reservation system that establishes a queue for use of the stations, allows users to enter the queue, notifies users when it is their turn to use the station, and only allows the next user in the queue to access the station.

One exemplary embodiment is a method that comprises using a back office server to establish a queue for an electric vehicle charging station (“EVCS”) or electric vehicle supply equipment (“EVSE”), and allowing a user to enter a queue for an EVCS/EVSE using a web-based internet application or an internet-connected device. In certain implementations, the user is allowed to enter the queue for the EVCS/EVSE using a display apparatus and access control device (such as a magnetic strip reader or RFID reader) at the EVCS/EVSE. A related embodiment comprises one or more computer-readable media storing computer-executable instructions which when executed by a processor cause the processor to perform the method.

Another exemplary embodiment comprises one or more computer-readable media storing computer-executable instructions which when executed by a computer cause the computer to establish a queue for an electric vehicle charging station (“EVCS”) or electric vehicle supply equipment (“EVSE”) and to allow a user to enter a queue for the EVCS/EVSE using a web-based application or an internet-connected device.

Another exemplary embodiment is a method implemented by an EVCS/EVSE in which, upon receiving data from a back office server that a particular individual has placed a reservation on the EVCS/EVSE, the EVCS/EVSE allows only the individual that placed the reservation to access the EVCS/EVSE for charging. A related embodiment comprises one or more computer-readable media storing computer-executable instructions which when executed by a processor (such as a processor at the EVCS/EVSE) cause the processor to perform the method.

Embodiments of the disclosed systems and methods can be implemented using computing hardware, such as a computer processor embedded in the EVCS/EVSE or internet-connected device to establish a user's place in the queue and to be notified when it is the user's turn to use the station. For example, embodiments of the disclosed methods can be performed using software stored on one or more non-transitory computer-readable media (e.g., one or more optical media discs, volatile memory components (such as DRAM or SRAM), or nonvolatile memory or storage components (such as hard drives)). Such software can be executed by a computer processor embedded in the EVCS/EVSE or by one or more computers coupled to the EVCS/EVSE by a network (e.g., via the internet, a wide-area network, a local-area network, a client-server network, or other such network). Embodiments of the disclosed methods can also be performed by specialized computing hardware (e.g., one or more application specific integrated circuits (“ASICs”) or programmable logic devices (such as field programmable gate arrays (“FPGAs”)) configured to perform any of the disclosed methods). Additionally, any intermediate or final result created or modified using any of the disclosed methods can be stored on a non-transitory storage medium (e.g., one or more optical media discs, volatile memory or storage components (such as DRAM or SRAM), or nonvolatile memory or storage components (such as hard drives)). Furthermore, any of the software embodiments (comprising, for example, computer-executable instructions which when executed by a computer cause the computer to perform any of the disclosed methods) or results (either intermediate or final) created or modified by the disclosed methods can be transmitted, received, or accessed through a suitable communication means.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic block diagram illustrating an exemplary electric vehicle charging system with a display device coupled to a back office serve via a network.

FIG. 2 is a schematic block diagram illustrating an exemplary EVCS/EVSE system integrated with an internet-connected device.

FIG. 3 is a flowchart of an exemplary method for using a round robin reservation system to control access to an EVCS/EVSE according to an embodiment of the disclosed technology.

FIG. 4 illustrates an exemplary EVCS/EVSE screen showing a possible user interface that will allow a user to enter the EVCS/EVSE queue at the EVCS/EVSE.

FIG. 5 is a schematic block diagram of an exemplary computing environment for implementing embodiments of the disclosed technology.

### DETAILED DESCRIPTION

### I. General Considerations

Disclosed below are representative embodiments of methods, apparatus, and systems for using and operating electric vehicle charging stations (“EVCSs”) or electric vehicle supply equipment (“EVSE”) with mobile device payment technology. The disclosed methods, apparatus, and systems should not be construed as limiting in any way. Instead, the present disclosure is directed toward all novel and nonobvious features and aspects of the various disclosed embodiments, alone and in various combinations and subcombinations with one another. Furthermore, any features or aspects of the disclosed embodiments can be used in various combinations and subcombinations with one another. The disclosed methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “monitor” to describe the disclosed methods. These terms are high-level abstractions of the actual operations that are performed. The actual operations that correspond to these terms may vary depending on the particular implementation and are readily discernible by one of ordinary skill in the art. Furthermore, as used herein, the term “and/or” means any one item or combination of items in the phrase.

Any of the disclosed methods can be implemented using computer-executable instructions stored on one or more computer-readable media (e.g., non-transitory computer-readable media, such as one or more volatile memory components (e.g., DRAM or SRAM), nonvolatile memory or storage components (e.g., hard drives, solid state drives, or flash memory), or optical media discs) and executed on a computer (e.g., any commercially available computer or a computer processor embedded in the EVCS/EVSE). Any of the intermediate or final data created and used during implementation of the disclosed methods or systems can also be stored on one or more computer-readable media (e.g., non-transitory computer-readable media).

For clarity, only certain selected aspects of the software-based embodiments are described. Other details that are well known in the art are omitted. For example, it should be understood that the software-based embodiments are not limited to any specific computer language or program. For instance, embodiments of the disclosed technology can be implemented by software written in C++, C#, Objective C, Java, Perl, JavaScript, Adobe Flash, or any other suitable programming language. Likewise, embodiments of the disclosed technology are not limited to any particular computer or type of hardware. Details of suitable computers and hardware are well known and need not be set forth in detail in this disclosure.

Furthermore, any of the software-based embodiments (comprising, for example, computer-executable instructions stored on a non-transitory computer-readable medium) can be uploaded, downloaded, or remotely accessed through a suitable communication means. Such suitable communication means include, for example, the internet, the World Wide Web, an intranet, cable (including fiber optic cable), magnetic communications, electromagnetic communications (including RF, microwave, and infrared communications), electronic communications, or other such communication means.

The disclosed methods can also be implemented using specialized computing hardware that is configured to perform any of the disclosed methods. For example, the disclosed methods can be implemented by an integrated circuit (e.g., an application specific integrated circuit (“ASIC”) or programmable logic device (“PLD”), such as a field programmable gate array (“FPGA”)) specially designed to implement any of the disclosed methods. The integrated circuit or specialized computing hardware can be embedded in or directly coupled to an EVCS/EVSE or device that is configured to interact with the EVCS/EVSE.

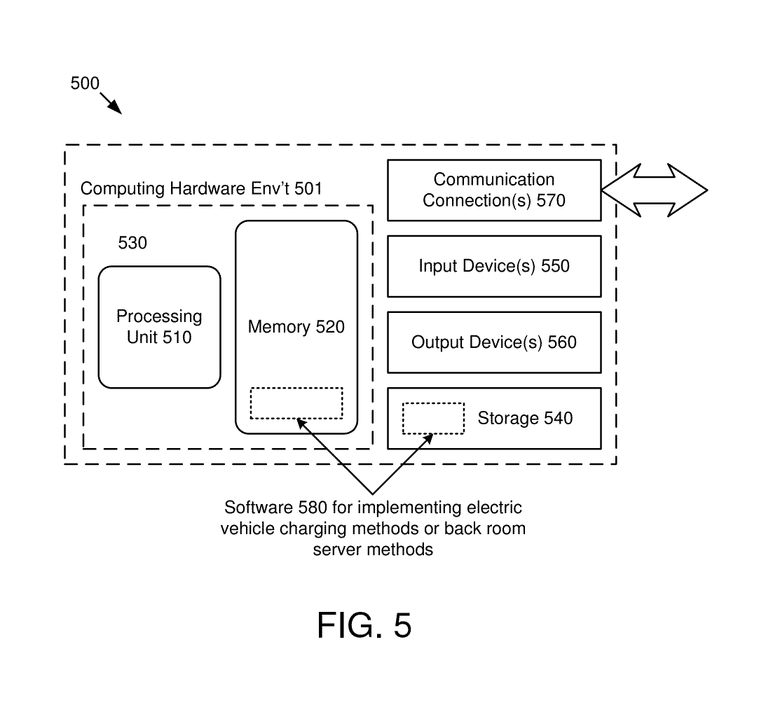

FIG. 5 is a schematic block diagram 500 that illustrates a generalized example of a suitable computing hardware environment 501 in which embodiments of the disclosed technology can be implemented. The computing hardware environment 501 is not intended to suggest any limitation as to the scope of use or functionality of the disclosed technology, as the technology can be implemented in diverse general-purpose or special-purpose computing environments.

With reference to FIG. 5, the computing hardware environment 501 includes at least one processing unit 510 and memory 520. In FIG. 5, this most basic configuration 530 is included within a dashed line. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM, DRAM, SRAM), non-volatile memory (e.g., ROM, EEPROM, flash memory), or some combination of the two. The memory 520 can store software 580 for implementing one or more of the described techniques for operating or using the disclosed electric vehicle charging systems. For example, the memory 520 can store software 580 for implementing any of the disclosed methods and their accompanying user interfaces.

The computing hardware environment can have additional features. For example, the computing hardware environment 501 includes storage 540, one or more input devices 550, one or more output devices 560, and one or more communication connections 570. An interconnection mechanism (not shown) such as a bus, controller, or network interconnects the components of the computing hardware environment 501. Typically, operating system software (not shown) provides an operating environment for other software executing in the computing hardware environment 501, and coordinates activities of the components of the computing hardware environment 501.

Storage 540 is a type non-volatile memory and can be removable or non-removable. The storage 540 includes, for instance, magnetic disks (e.g., hard drives), solid state drives, flash memory, magnetic tapes or cassettes, optical storage media (e.g., CD-ROMs or DVDs), or any other tangible non-transitory storage medium which can be used to store information and which can be accessed within or by the computing hardware environment 501. The storage 540 can store the software 580 for implementing any of the described techniques, systems, or environments.

The input device(s) 550 can be a touch input device such as a keyboard, mouse, touch screen, pen, trackball, a voice input device, a scanning device, or another device that provides input to the computing environment 501. The output device(s) 560 can be a display, touch screen, printer, speaker, or another device that provides output from the computing environment 501.

The communication connection(s) 570 enable communication over a communication medium to another computing entity. The communication medium conveys information such as computer-executable instructions, any of the intermediate or final messages or data used in implementing embodiments of the disclosed technology, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier. For example, the communication connection(s) 570 can communicate with another computing entity over a wired or wireless network (e.g., the internet, a wide-area network, a local-area network, a Wi-Fi network, a client-server network, a wireless network (such as a cellular network, a 900 MHz network, a Zigbee network, or other wireless network) or other such network or any combination thereof).

Many of the methods, systems, and interfaces disclosed herein can be described in the general context of computer-executable instructions stored on one or more computer-readable media. Computer-readable media are any available media that can be accessed within or by a computing environment. By way of example, and not limitation, with the computing hardware environment 501, computer-readable media include tangible non-transitory computer-readable media such as memory 520 and storage 540 and do not encompass transitory carrier waves or signals. The various methods, systems, and interfaces disclosed herein can also be described in the general context of computer-executable instructions, such as those included in program modules, being executed in a computing environment on a target processor. Generally, program modules include routines, programs, libraries, objects, classes, components, data structures, and the like that perform particular tasks or implement particular abstract data types. The functionality of the program modules may be combined or split between program modules as desired in various embodiments. Computer-executable instructions for program modules may be executed within a local or distributed computing environment.

### II. Exemplary Embodiments of the Disclosed Technology

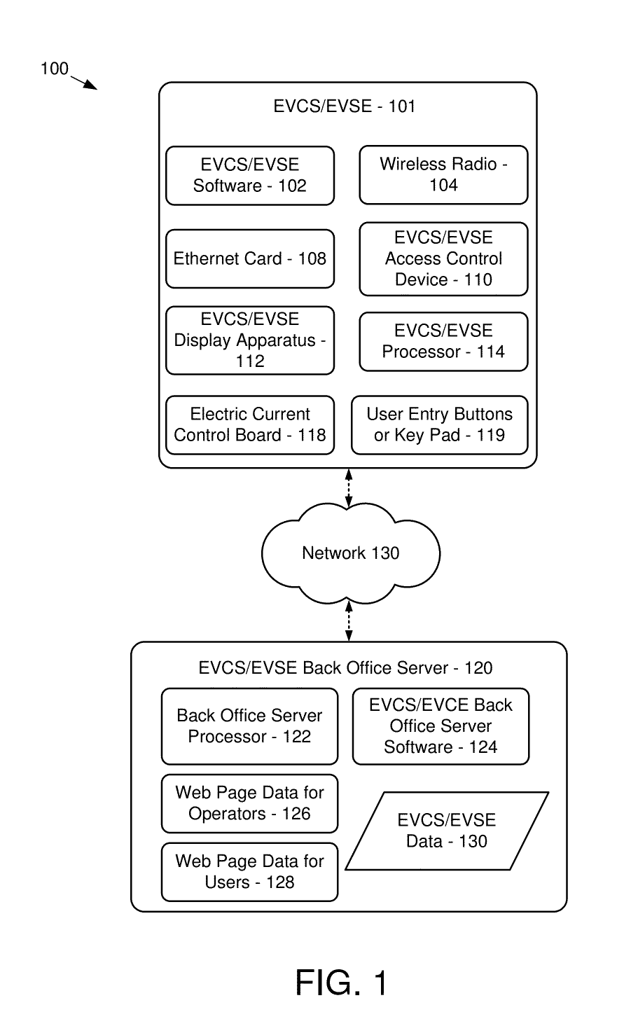

FIG. 1 is a schematic block diagram 100 illustrating an EVCS/EVSE computing hardware environment 101 for implementing embodiments of the disclosed technology. In particular, FIG. 1 illustrates an exemplary computing hardware environment 101 for an EVCS/EVSE and an exemplary computing hardware environment 120 for an EVCS/EVSE back office server. The EVCS/EVSE environment 101 is more specialized than computing hardware environment 501 but should not be construed as limiting the types of hardware that can be used to implement the disclosed technology. Furthermore, the EVCS/EVSE environment 101 and the exemplary computing hardware environment 120 for the EVCS/EVSE back office server can include any of the components described above with respect to the general computing hardware environment 501.

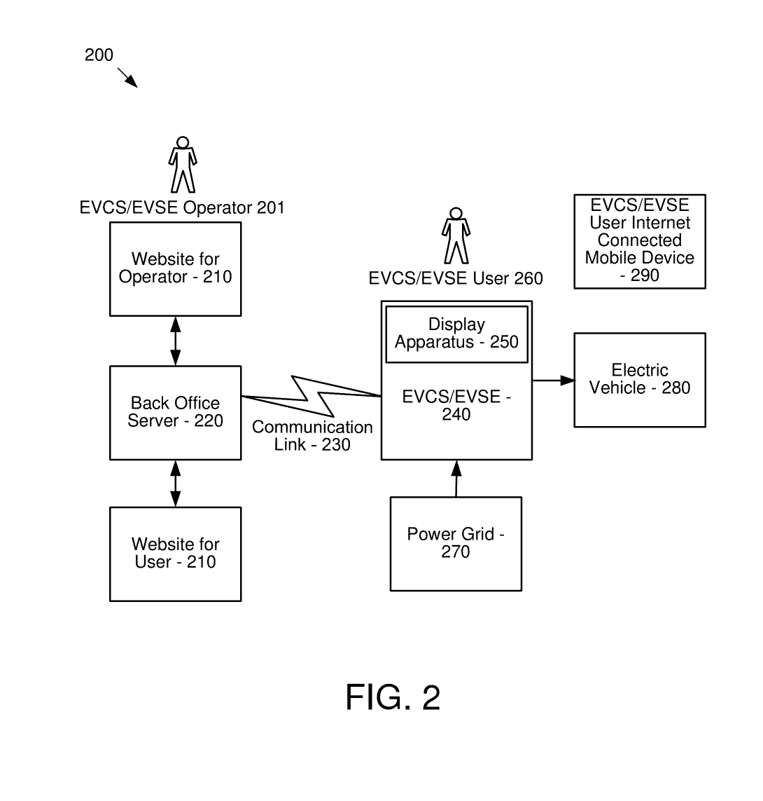

The EVCS/EVSE computing hardware environment 101 includes software 102, which comprises computer-executable instructions stored on non-transitory computer-readable media (e.g., any one or more of the non-transitory computer-readable media described above). When executed, the software can be used to implement the functionality of the EVCS/EVSE, which is described in more detail below. The EVCS/EVSE computing hardware environment 101 further comprises an EVCS/EVSE processor 114 for executing the software 102. Suitable processors and associated parts can be obtained, for example, from Parvus Corporation. In the illustrated embodiment, the EVCS/EVSE processor 114 is interconnected to an electric current control board 118. The electric current control board 118, in turn, is connected to the cables and electrical connectors of the EVCS/EVSE that provide the electrical coupling to the one or more electric vehicles (e.g., using a SAE J1772™ connector, IEC 62196 electrical connector, or other such electric vehicle connector). Suitable electric current control boards and associated parts can be obtained, for example, from Texas Instruments, Riley Corp, and National Control Devices. In certain exemplary embodiments, the EVCS/EVSE software 102 is used to implement a process in which commands and data are exchanged to control the flow of electrical current to one or more electric vehicles plugged into the EVCS/EVSE (e.g., the EVCS/EVSE 240 shown in FIG. 2) and the payment for the delivery of this electrical current. The EVCS/EVSE computing hardware environment 101 can also include one or more of a wireless radio 104, and/or an Ethernet card 108 (or other network adapter) to provide the environment 101 with a wired and wireless interface capabilities for exchanging data with, for example, an EVCS/EVSE back office server 120. Suitable wireless radios and associated parts can be obtained, for example, from Digi International. Suitable cellular radios and associated parts can be obtained, for example, from Telit Communications Plc. The EVCS/EVSE computing hardware environment 101 also includes access control device 110, and a display apparatus 112, such as an LCD or LED. Another possible option to facilitate user interaction is using a display device combined with a set of user entry buttons or a keypad 119. Suitable magnetic card readers and associated parts can be obtained, for example, from ID Tech. Suitable display devices and touch screen interfaces can be obtained, for example, from Logic Supply.

As more fully described below, the display apparatus 112 can be used to facilitate the charging of the electric vehicle and the proper billing (or crediting) for the electricity used by (or supplied to) the electric vehicle coupled to the EVCS/EVSE. As shown in FIG. 1, the EVCS/EVSE computing hardware environment 101 is coupled to the EVCS/EVSE back office server environment 120 via the network 130 (e.g., the internet, a wide-area network, a local-area network, a Wi-Fi network, a client-server network, a wireless network (such as a cellular network, a 900 MHz network, a Zigbee network, or other wireless network) or other such network or any combination thereof). In particular embodiments, the back office server environment 120 is implemented as part of a cloud-based back office server.

In operation, the EVCS/EVSE computing hardware environment 100 can create a number of data packets or messages that are transmitted to the EVCS/EVSE back office server environment 120 via a network 130. The EVCS/EVSE back office server environment 120 can receive these packets or messages and can also create data packets or messages that will be transmitted to the EVCS/EVSE computing hardware environment 101 via the network 130. An exemplary method and system for communicating between the EVCS/EVSE computing hardware environment 101 and the back office server environment 120 is described below in connection with.

Returning to FIG. 1, the back office server environment 120 can be implemented using a wide variety of computers and/or servers (e.g., a suitable commercially available server). In FIG. 1, the back office server environment 120 includes back office server software 124, which can comprise computer-executable instructions stored on non-transitory computer-readable media (e.g., any one or more of the non-transitory computer-readable media described above). When executed, the software can be used to implement the functionality of the back office server, which is described in more detail below. The EVCS/EVSE back office server 120 further comprises a back office server processor 122 for executing software 124. Also shown in FIG. 1 is EVSC/EVSE data 130, which includes databases of the users of the system but also database of charging events on the system. The EVSC/EVSE data 130 can comprise data stored on non-transitory computer-readable media that is related to users of the EVCS/EVSE. For example, the data can include data about a user's identification, address, account credit balance, usage history, vehicle, and/or other such user data.

In the illustrated embodiment, the EVCS/EVSE back office server 120 also includes data 126 for implementing one or more web pages for an EVCS/EVSE operator (e.g., an entity responsible for maintaining, servicing, and controlling the EVCS/EVSE so that they may be used by users). The web page data 126 can comprise data stored on non-transitory computer-readable media that is used to render or otherwise implement one or more web pages for display to an EVCS/EVSE operator. The web pages can be displayed, for example, using a suitable internet browser or media player implemented at a computer operated by the EVCS/EVSE operator and coupled to the back office server 120 via a network (e.g., the internet, a wide-area network, a local-area network, a Wi-Fi network, a client-server network, a wireless network (such as a cellular network, a 900 MHz network, a Zigbee network, or other wireless network), or other such network or any combination thereof). The web page data can be in any format or language suitable for implementing web pages (e.g., HTML, Flash, Java, and the like). In other embodiments, the data to be displayed to the EVCS/EVSE operator is not stored as web page data, but as data usable via a non-web-based user interface (e.g., a dedicated program that directly interfaces with the back office server 120).

The EVCS/EVSE back office server 120 can also include data 128 for implementing one or more web pages for an EVCS/EVSE user. The web page data 128 can comprise data stored on non-transitory computer-readable media that is used to render or otherwise implement one or more web pages for display to an EVCS/EVSE user. The web pages can be displayed, for example, using a suitable internet browser or media player implemented at a computer operated by the EVCS/EVSE user and coupled to the back office server 120 via a network (e.g., the internet, a wide-area network, a local-area network, a Wi-Fi network, a client-server network, a wireless network (such as a cellular network, a 900 MHz network, a Zigbee network, or other wireless network) or other such network or any combination thereof). The web page data can be in any format or language suitable for implementing web pages (e.g., HTML, Flash, Java, and the like). In other embodiments, the data to be displayed to the EVCS/EVSE user is not stored as web page data, but as data usable via a non-web-based user interface (e.g., a dedicated program that directly interfaces with the back office server 120). In certain embodiments, the web page data 128 is data for implementing web pages that allow the user to place themselves in a queue for an EVCS/EVSE and/or to show the user information about the state of the user's account (including, for example, the amount of credit balance and/or purchase history). For instance, in a particular implementation, the web page data can include data for implementing a log-in screen through which the user provides authentication information indicating that the user is a member of a group authorized to use an EVCS/EVSE in a network of EVCSs/EVSE controlled by the back EVCS/EVSE back office server 120, and data for implementing an account status screen through which the user is presented a graphical or numerical indication of the state of the user's account. The EVCS/EVCE back office server software 124 can include code that receives information about the identity of the user at the log-in screen, matches the identity to an EVCS user database, and causes the display of the information about the state of the user's account via one or more web pages or other displays displayed to the user. The information about the user's account can comprise, for instance, a user's position in the queue for an EVCS/EVSE, the current credit balance in the account, the method of payment (e.g., credit/debit card or bank account information) to be used for electric charging payment purposes, and a record of past charges against this account.

FIG. 2 is a schematic block diagram 200 illustrating an exemplary EVCS/EVSE system and the users of the exemplary system. In FIG. 2, a user 260 interfaces with an EVCS/EVSE 240 using a display apparatus 250 (e.g., a touch screen interface). The display apparatus 250 allows the user to view operating instructions and/or to make entries of information. As noted above, the functionality of the display apparatus 250 can be implemented by executing appropriate EVCS/EVSE software stored at the EVCS/EVSE (e.g., EVCS/EVSE software 102). The EVCS/EVSE 240 uses a communication device (e.g., one or more of the wireless radio 104 (such as a cellular radio) or Ethernet card 108 shown in FIG. 1) to establish a communication link 230 with a back office server 220. The functionality of the back office server 220 can be implemented by executing appropriate back office software stored at the back office server 220 (e.g., back office server software 124). The EVCS/EVSE 240 also uses the communication device to transmit information entered by the user 260 to the back office server 220. This information can comprise, for example, entries made by the user via the display apparatus 250.

The back office server 220 in FIG. 2 is also configured to operate a website 210 for exchanging information related to the EVSE/EVSE with the EVCS/EVSE user 260. The information can comprise, for example, the current status of the user's account, account records for the user, or other such information. For example, in embodiments of the disclosed technology, the user 260 can use this website to enter themselves in a queue for a charging station and receive notifications when it is their turn to use the station.

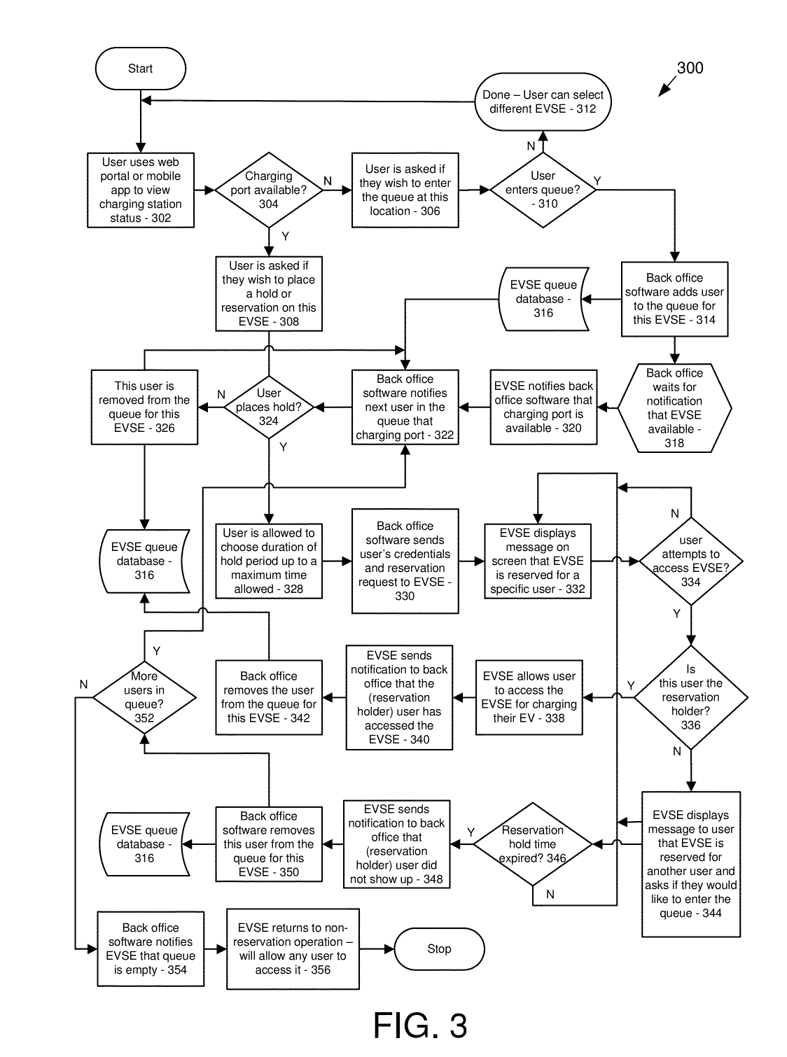

FIG. 3 is a flow chart 300 showing an exemplary process for adding users to a queue to use an EVCS/EVSE and for managing the queue using aspects of the disclosed technology. As noted above, the functionality shown in FIG. 3 can be implemented by computing hardware executing computer-executable instructions. The functionality described in FIG. 3 can be provided at least in part through a dedicated application on a user's internet-connected device or by an internet web site accessed by the user's device. The various procedures shown in FIG. 3 should not be construed as limiting, as any one or more of the procedures can be performed alone or in various other combinations and subcombinations in accordance with the disclosed technology.

In particular embodiments, the user uses an internet-connected device, such as a smartphone, tablet, or other personal computer, to view the status of a particular charging station that they are interested in using (process block 302). If a charging port is available on the desired charging station (process block 304), the user will be asked if they wish to place a hold or a reservation on this port (process block 308) (e.g., via a prompt on a display of the user's internet-connected device). If all of the ports are in use, the user will be asked if they wish to enter a queue for this charging station (process block 306). The queue can be maintained in a database, data structure, or file stored and updated at the back office server. Or, in some embodiments, the queue can be maintained and managed in a database, data structure, or file stored and updated at the EVCS/EVSE. For ease of presentation, the embodiments below will be described in connection with a back office server, but it should be understood that any of the functions performed by the back office server can be performed by the EVCS/EVSE itself. If the user does not elect to enter the queue (process block 310), the user can select a different EVCS/EVSE and start the process again (process block 312). If the user does elect to enter the queue for this EVCS/EVSE, the back office software will add this user to the queue for this particular EVCS/EVSE (process block 314 and 316). If there are one or more users in the queue for a particular EVCS/EVSE, the back office will wait to receive notification from the EVCS/EVSE that this EVCS/EVSE has an available charging port (e.g., as will occur when the previous user in the queue has completed their charging session nor after expiration of a time period for which the port is reserved for the previous user in the queue) (process block 318).

When the back office receives notification from the particular EVCS/EVSE that a charging port is available (process block 320), the back office will notify the next user in the queue for this EVCS/EVSE that a port is available (process block 322). This notification can be via an e-mail message, SMS text message, and/or through an EVCS/EVSE application running on the user's internet-connected mobile device. During the time it has taken for a charging port to become available, this particular user's needs may have changed, so along with the notification, the back office will ask the user if they wish to place a hold on this EVCS/EVSE to allow them time to get there (e.g., via a user-interface prompt or through a request for a return message). If the user elects not to place the hold on the EVCS/EVSE (process block 324), this user will be removed from the queue for this particular EVCS/EVSE (process block 326) and the back office will notify the next user in line in the queue that there is a charging port available (process block 322). If the user does elect to place a hold on this EVCS/EVSE, the user will either be informed by the back office of the duration of their hold, or the user can be allowed to choose a duration for the hold (up to some maximum time), to allow the user time to travel to the EVCS/EVSE (process block 328). The back office will then send the user's credentials along with the hold/reservation request (e.g., including data that specifies the amount of time to hold the station for) to the EVCS/EVSE (process block 330). Once the EVCS/EVSE receives this information from the back office, the EVCS/EVSE can display a message on its display apparatus that this EVCS/EVSE is reserved (process block 332). It should be noted that for privacy concerns, the displayed message would typically not include the user's name or other identification information (though in some implementations it may).

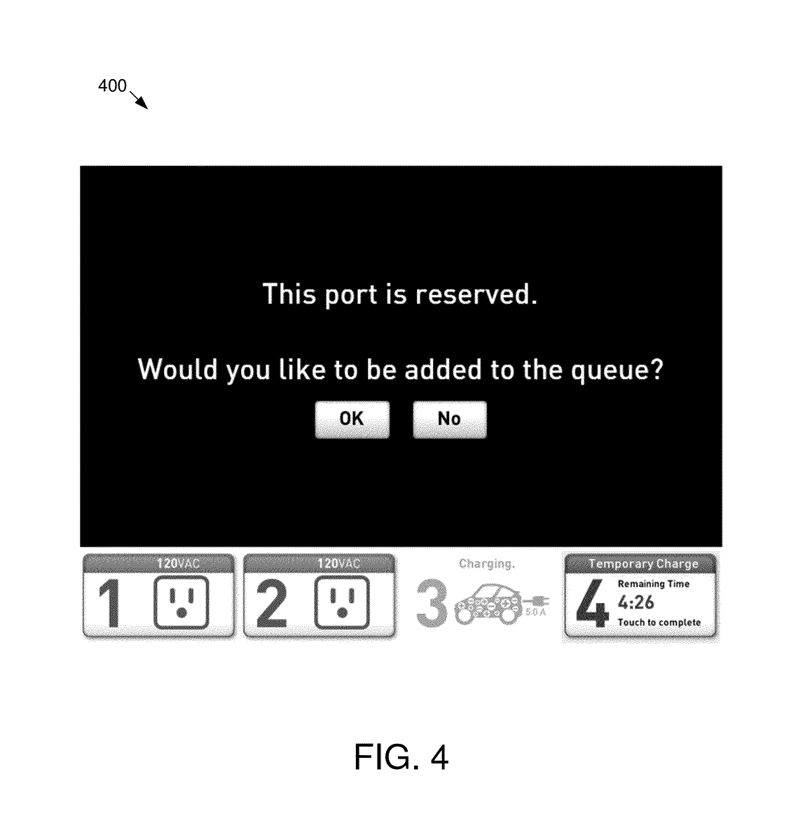

When any user attempts to access this particular EVCS/EVSE (process block 334), the EVCS/EVSE will determine if this user is the individual that placed the hold on it (process block 336). For example, the EVCS/EVSE can use the user's identification token (e.g., a card, a radio frequency identification tag, entry of the user's identity credentials using the display apparatus, and/or an EVCS/EVSE payment application running on the user's internet-connected mobile device) to determine the user's identity. If the user attempting to access the EVCS/EVSE is the individual that placed the hold, the EVCS/EVSE will allow this user to access the EVCS/EVSE to charge their vehicle (process block 338) using the reserved charging port. If the user attempting to access the EVCS/EVSE is not the individual that placed the hold on it, the EVCS/EVSE will display a message to this user that this particular EVCS/EVSE is reserved for another user. The EVCS/EVSE will also ask the user if they wish to enter the queue for the station (process block 344). An example screen that would be shown on the display apparatus asking the user if they would like to enter the queue is show in the FIG. 4. If this user wishes to enter the queue, the process will start for this user at process block 314.

Once the reservation holder accesses the EVCS/EVSE (process block 338), the EVCS/EVSE sends a message to the back office that the individual with a hold on the EVCS/EVSE has accessed the station (process block 340). Once the back office receives this notification, it will remove the user from the queue for this EVCS/EVSE (process block 342 and process block 316).

Recall that when the user placed the hold on this EVCS/EVSE in process block 324 & 328) they were either informed of the amount of time that this hold would be valid for, or they were allowed to specify a time that this hold would be valid for. If the hold time expires before this particular user arrives at the EVCS/EVSE (process block 346), the EVCS/EVSE will send a notification to the back office that the reservation holder did not access the EVCS/EVSE before the hold time expired (process block 348) (or, in other embodiments, the back office server will determine the reservation expired because it failed to receive a message that charging has been initiated by the user). If the back office receives this notification, it will remove this user from the queue for this particular EVCS/EVSE (process block 350 & 316). If there are more users in the queue (process block 352), the back office will notify the next user in the queue for this particular EVCS/EVSE that the EVCS/EVSE is available (process block 322). If there are no more users in the queue, the back office will send a message to the EVCS/EVSE that the queue is empty (process block 354). If the EVCS/EVSE receives the message that its queue is empty, the EVCS/EVSE will cease to display the message that it is reserved for a specific user and will allow any user to access it (process block 356).

### III. Further Embodiments

Having described and illustrated the principles of the disclosed technology in the detailed description and accompanying drawings, it will be recognized that the various embodiments can be modified in arrangement and detail without departing from such principles. Furthermore, any features or aspects of the disclosed embodiments can be used in various combinations and subcombinations with one another.

For example, one alternative embodiment comprises receiving data from a user, or from the user's vehicle, indicating a current charge state of the user's vehicle's battery (e.g., a percentage of power remaining or the number of miles until empty) when the user places themselves in the queue for the EVCS/EVSE. In this embodiment, instead of maintaining the queue as a first-in, first-out queue, the back office server can continually re-order the queue so that the user with the vehicle with the most critical battery charge state (e.g., the lowest percentage of power remaining or fewest miles to empty) is placed first in the queue and the remaining users are organized in the queue in order of increasing battery charge state. Variations on this embodiment include establishing a minimum battery charge state to perform the queue re-ordering. In this variation, users with a vehicle battery charge state below this minimum state will be placed at the front of the queue in order of lowest to highest battery charge state. Users with a vehicle battery charge state higher than this minimum state will be ordered in the queue behind those with states below the minimum in the order that they entered the queue.

Furthermore, it is to be understood that any of the features and embodiments described herein can be used in combination with any of the features and embodiments described in U.S. Nonprovisional application 14/065,200 filed on Oct. 28, 2013, and entitled “SYSTEM FOR COMBINING PAYMENT FOR ELECTRIC VEHICLE CHARGING AND PARKING”; U.S. Provisional Application No. 61/719,483 filed on Oct. 28, 2012, and entitled “SYSTEM FOR COMBINING PAYMENT FOR ELECTRIC VEHICLE CHARGING AND PARKING”; U.S. Nonprovisional Application No. 14/047,842 filed on Oct. 5, 2013, and entitled “SYSTEM FOR PARKING PAYMENT USING A MOBILE DEVICE”; U.S. Provisional Application No. 61/710,643 filed on Oct. 5, 2012, and entitled “SYSTEM FOR PARKING PAYMENT USING A MOBILE DEVICE”; U.S. Nonprovisional Application No. 14/014,108, filed on Aug. 29, 2013 and entitled “ELECTRIC VEHICLE CHARGING STATION MOBILE DEVICE PAYMENT SYSTEM”; U.S. Provisional Application No. 61/694,647, filed on Aug. 29, 2012, and entitled “ELECTRIC VEHICLE CHARGING STATION MOBILE DEVICE PAYMENT SYSTEM”; and U.S. Provisional Application No. 71/728,134, filed on Nov. 19, 2012, and entitled “RESERVATION SYSTEMS FOR ELECTRIC VEHICLE CHARGING STATIONS”, all of which hereby incorporated herein by reference.

Furthermore, it is to be understood that any of the features and embodiments described herein can be used in combination with any of the features and embodiments described in U.S. Provisional Application No. 61/307,318, filed on Feb. 23, 2010, and entitled “ELECTRIC VEHICLE CHARGING STATION WITH TOUCH SCREEN USER INTERFACE”; U.S. Provisional Application No. 61/409,108, filed on Nov. 1, 2010, and entitled “ELECTRIC VEHICLE CHARGING STATION WITH TOUCH SCREEN USER INTERFACE”; U.S. Provisional Application No. 61/307,377, filed on Feb. 23, 2010, and entitled “ELECTRIC VEHICLE CHARGING STATION ADVERTISING SYSTEM”; U.S. Provisional Application No. 61/353,944, filed on Jun. 11, 2010, and entitled “ELECTRIC VEHICLE CHARGING STATION ADVERTISING SYSTEM”; U.S. Provisional Application No. 61/317,181, filed on Mar. 24, 2010, and entitled “ELECTRIC VEHICLE CHARGING STATION PARKING METER SYSTEM”; U.S. Nonprovisional application Ser. No. 12/954,209, filed on Nov. 24, 2010, and entitled “ELECTRIC VEHICLE CHARGING STATION ADVERTISING SYSTEMS” (published as U.S. Patent Application Publication No. 2011/0204847), U.S. Nonprovisional application Ser. No. 13/033,179, filed on Feb. 23, 2011, and entitled “ELECTRIC VEHICLE CHARGING STATIONS WITH TOUCH SCREEN USER INTERFACE” (published as U.S. Patent Application Publication No. 2011/0213656), and U.S. Nonprovisional application Ser. No. 13/070,389, filed on Mar. 23, 2011, and entitled “ELECTRIC VEHICLE CHARGING STATION PARKING METER SYSTEMS” (published as U.S. Patent Application Publication No. 20110239116), all of which are hereby incorporated herein by reference.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims and their equivalents. We therefore claim as our invention all that comes within the scope and spirit of these claims and their equivalents.

What is claimed is:

1. A method of controlling access to an electric vehicle charging station (“EVCS”) or electric vehicle supply equipment (“EVSE”), comprising:
establishing a queue for the EVCS or EVSE at a remote server or other queue management device, the queue being an ordered list of users that desire to use the EVCS or EVSE for charging;
notifying a next user in the queue to use the EVCS or EVSE when the EVCS or EVSE becomes available; and
allowing the next user in the queue to specify whether or not the next user would still like to use the EVCS or EVSE at the time it becomes available and, if the next user indicates that they would still like to use the EVCS or EVSE at the time it becomes available, allowing the next user to place a hold on the EVCS or EVSE for a time period.

2. The method of claim 1, further comprising:
sending a message to the EVSE or EVCS that includes identification data of the next user placing a hold on the EVCS or EVSE and a duration of the time period of the hold.

3. The method of claim 1, further comprising displaying a message at the EVCS or EVSE that the EVCS or EVSE is reserved;

4. The method of claim 1, further comprising restricting access to the EVCS or EVSE to allow access only to the next user that placed the hold on the EVCS or EVSE.

5. The method of claim 1, further comprising displaying a message to an other user at the EVCS or EVSE that allows the other user to join queue at the end of the queue.

6. The method of claim 1, further comprising deleting the next user from the queue once the next user either (a) plugs the next user's vehicle into the EVCS or EVSE, (b) specifies that the next user no longer wants to use the EVCS or EVSE, or (c) fails to plug the next user's vehicle into the EVCS or EVSE before the time period of the hold expires.

7. The method of claim 1, further comprising allowing a user to view the status of the EVCS or EVSE and place themselves at the end of the queue to use the EVCS or EVSE.

8. The method of claim 7, further comprising allowing the next user in the queue to specify whether or not the next user would still like to use the EVCS or EVSE at the time it becomes available via an internet portal or an internet-connected device.

9. The method of claim 1, further comprising notifying the EVCS or EVSE that there are users in the queue to use the EVCS or EVSE.

10. The method of claim 1, wherein the EVCS or EVSE notifies a remote server electronically when a charging session ends at the EVCS or EVSE and the EVCS or EVSE is available for another user.

11. The method of claim 1, wherein the notifying is performed using one or more of a SMS text message, an electronic mail message, or messaging through an application on an internet-connected device.

12. The method of claim 1, further comprising:
receiving identity data from a user attempting to access the EVCS or EVSE via a magnetic card, radio frequency identification token, or an application running on the user's internet-connected device; and
comparing the identity data to identity data of the user that has placed the hold on the EVCS or EVSE

13. The method of claim 1 wherein the queue is ordered in one of the following orders:
in a chronological order based on when the users entered the queue,
in an order in which lower battery charge states are ordered before higher battery charge states, or
in an order in which lower battery charge states are ordered before higher battery charge states up to a minimum battery charge state, and thereafter according to a chronological order based on when the users entered the queue.

14. The method of claim 1, wherein the queue is for a collection of EVCSs or EVSE in an area, and wherein the method further comprises notifying the next user when one of the EVCS or EVSE in the area becomes available for use.

15. One or more non-transitory computer-readable media storing computer-executable instructions which when executed by the computer processor cause the computer processor to perform a method, the method comprising:
establishing a queue for the EVCS or EVSE at a remote server or other queue management device, the queue being an ordered list of users that desire to use the EVCS or EVSE for charging;
notifying a next user in the queue to use the EVCS or EVSE when the EVCS or EVSE becomes available; and
allowing the next user in the queue to specify whether or not the next user would still like to use the EVCS or EVSE at the time it becomes available and, if the next user indicates that they would still like to use the EVCS or EVSE at the time it becomes available, allowing the next user to place a hold on the EVCS or EVSE for a time period.

16. An electric vehicle charging station (“EVCS”) or electric vehicle supply equipment (“EVSE”) comprising:
one or more charging ports configured to be coupled to an electric vehicle and to charge one or more batteries of the electric vehicle;
a display device;
a computer processor, the computer processor being programmed to:
cause the display device to display a message indicating that the EVCS or EVSE is reserved,
allow a user to select to place themselves in a queue to use the EVCS or EVSE, and
receive an indication of a hold period for which the EVCS or EVSE should hold the EVCS or EVSE for a user that has reserved the EVCS or EVSE.

17. The EVCS or EVSE of claim 16, wherein the computer processor is further programmed to:
notify a remote server or queue management device that a next scheduled user has accessed the EVCS or EVSE; or
notify the remote server or queue management device that the hold period has expired without the next scheduled user accessing the EVCS or EVSE.

18. The EVCS or EVSE of claim 16, wherein the computer processor is further programmed to receive an indication from a remote server or queue management device that a user at the EVCS or EVSE is authorized to use the EVCS or EVSE.

19. The EVCS or EVSE of claim 16, wherein the indication is received via wireless communication.
